(19) United States
(12) Patent Application Publication
(10) Pub. No.: US 2009/0114779 A1
(43) Pub. Date: May 7, 2009

(54) Merchandising storage and display device

(75) Inventors: Timothy C. Carr, Woodburry, MN (US); Joy L. Harper, St.Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/288,190

(22) Filed: Oct. 17, 2008

Related U.S. Application Data
(60) Provisional application No. 60/981,232, filed on Oct. 19, 2007.

(51) Int. Cl. F16M 11/00

(52) U.S. Cl. 248/146

(57) ABSTRACT

A merchandising storage and display device with a storage cavity that may be configured into different dimensions.

### CROSS-REFERENCE TO PRIORITY APPLICATION

This application claims priority to U.S. Provisional Patent Application No. 60/981,232, filed Oct. 19, 2007, which is incorporated herein by reference in its entirety.

### FIELD OF INVENTION

The present invention generally relates to merchandising display and storage devices for use in storing and displaying a plurality of articles, e.g., consumer goods such as tape, tape dispensers, repositionable notes, repositionable flags, writing instruments, sponges, etc. In particular, it relates to merchandising display and storage devices sometimes referred to as sidekicks.

### BACKGROUND

A wide variety of systems exist to display merchandise in retail environments. Merchandising displays in retail stores are designed to allow an unobstructed view of the goods, easy removal and replacement of goods on the display, and the capability of storing an inventory of goods on the display to limit the frequency of display restocking. Because retail product display space is expensive and at a premium, merchandising fixtures and displays have been designed to utilize as much of the retail display space as possible.

Commonly retail store locations utilize various shelving configurations to display items to consumers. The shelving is preferably inexpensive, easy to install, capable of housing and displaying a large number of items, and easily restocked. A variety of fixtures or units for displaying merchandise have been employed in retail outlets. Two of the most widely used fixtures are “gondola” units and “H-frame” units typically featuring long rows of shelving facing aisles on either side with additional shelving sometimes referred to an endcaps at the ends. Such units have different appearances, and are often employed for displaying different types of merchandise, but both are commonly used in the same retail establishment. Gondola fixtures generally comprise a base, typically square or rectangular in shape, which mounts a pair of opposed vertical uprights or supports extending upwardly from the center portion thereof at each end, and, in many embodiments, one or more vertical supports at spaced intervals between the ends. The vertical supports are frequently provided with elongated slots or openings to receive brackets for the purpose of mounting shelves, product hangars, and the like for displaying products. In some instances, a sheet of peg board is retained by the opposed vertical supports in an upright position, with one edge of the peg board supported on the base, so that the base is essentially divided in half on opposite sides of the peg board. Hooks or brackets are received within the holes of the peg board to mount merchandise to the display. In other embodiments, horizontal elements such as shelves, baskets, etc. are attached to the vertical supports or a panel extending therebetween. In most designs, H-frame units comprise a base which is generally rectangular in shape having four vertical posts each extending upwardly from one of the corners of the base. A horizontally extending arm or beam is mounted between the corner posts on the opposite side, with an opposed horizontal beam mounted to the opposite set of corner posts, to provide a support for a horizontally extending shelf whose overall area is approximately equal to that of the base. One or more shelves are mounted along the vertical posts in this fashion to support merchandise.

A number of fixtures such as trays, racks, shelves, hooks, hangers, chutes, and the like have been suggested to increase the capacity and marketing effectiveness of basic gondola or H-frame installation.

Illustrative embodiments of such gondola or other shelf structures and fixtures used therewith are disclosed in, for example, U.S. Pat. Nos. 3,971,477, 3,976,201, 4,068,855, 4,707,940, 4,785,946, 5,133,463, 5,356,106, 5,918,750, 5,924,367, 6,070,841, 6,193,083, 6,206,212, 6,484,894, 6,659,294, 6,675,978, 6,929,133, 7,100,878, 7,195,123, 7,311,212, and 7,404,533.

Despite the great variety of merchandising storage and display fixtures that exists, there remains a need for improved fixtures. Improved convenience, flexibility, and reduced costs are continuing goals of retailers. A developing marketing practice is to cross-merchandise. This practice, sometimes referred to as related item merchandising involves setting up displays of complementary merchandise in relative proximity such that a shopper is tempted to “cross over” from one product to another. For example, rather than position rolls of adhesive tape at only one location in a store, a retailer may choose to position them in a multiple locations, e.g., with office supplies, with the gift card and wrapping section, etc. Some of these locations within the store may be seasonal, e.g., “back-to-school”, holidays, etc. such that the retailer changes them over every few weeks.

### SUMMARY OF INVENTION

The present invention provides an improved merchandising storage and display device, referred to herein as a sidekick. Sidekicks of the invention provide improved marketing capability, convenience, flexibility, and cost control for retailers while permitting them to provide easier, pleasing shopping environments to customers.

In brief summary, a merchandising device of the invention comprises:
a first side panel which is wider at its bottom end than at its top end;
a second side panel substantially equal to the first side panel in size and shape;
a back panel having an interior surface and an exterior surface and extending from the first side panel to the second side panel;
a front upper panel having an interior surface and an exterior surface and extending from the first side panel to the second side panel;
a front lower panel having an interior surface and an exterior surface and extending from the first side panel to the second side panel;
a bottom panel extending from the bottom of the first side panel to the bottom of the second side panel;
   which define a cavity into which one or more of dividers extend at least partially into. The front upper panel and front lower panel are positioned relative to one another to leave a gap or space therebetween which communicates with the cavity and through which goods may be removed.

The sidekicks described herein provide retailers with a convenient and easy way to enhance their product display installations. Among the advantages provided herein are improved use of retail space, enhanced cross-merchandising capabilities, and convenient flexibility for retailers and more convenient shopping for consumers.

### BRIEF DESCRIPTION OF DRAWINGS

The invention will be further explained with reference to the following drawings wherein:

FIG. 1 is perspective view of one embodiment of a sidekick of the invention;

FIG. 2 is a plan view of the front face of the sidekick shown in FIG. 1;

FIG. 3 is a plan view of the right side of the sidekick shown in FIG. 1; and

FIG. 4 is a plan view of the top of the sidekick shown in FIG. 1.

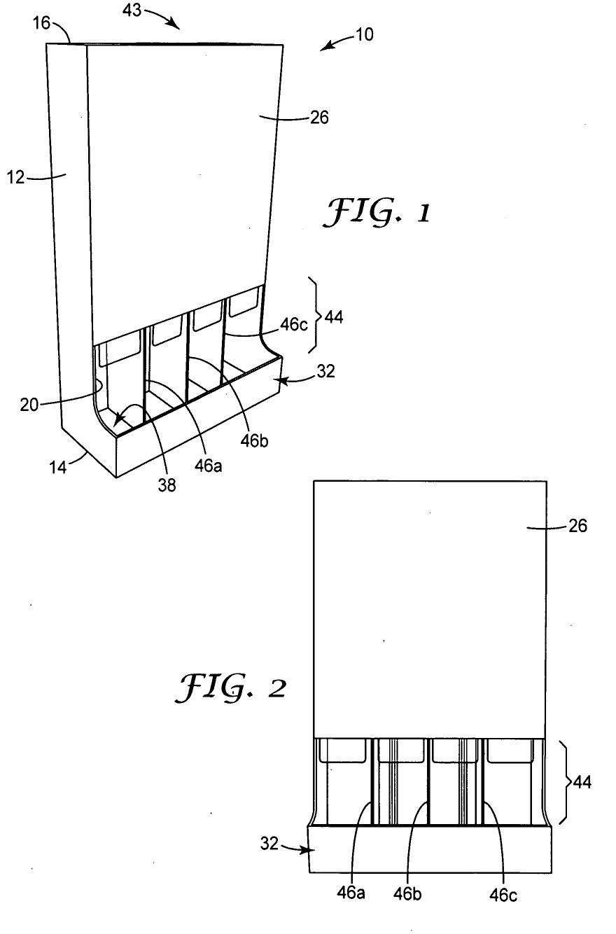

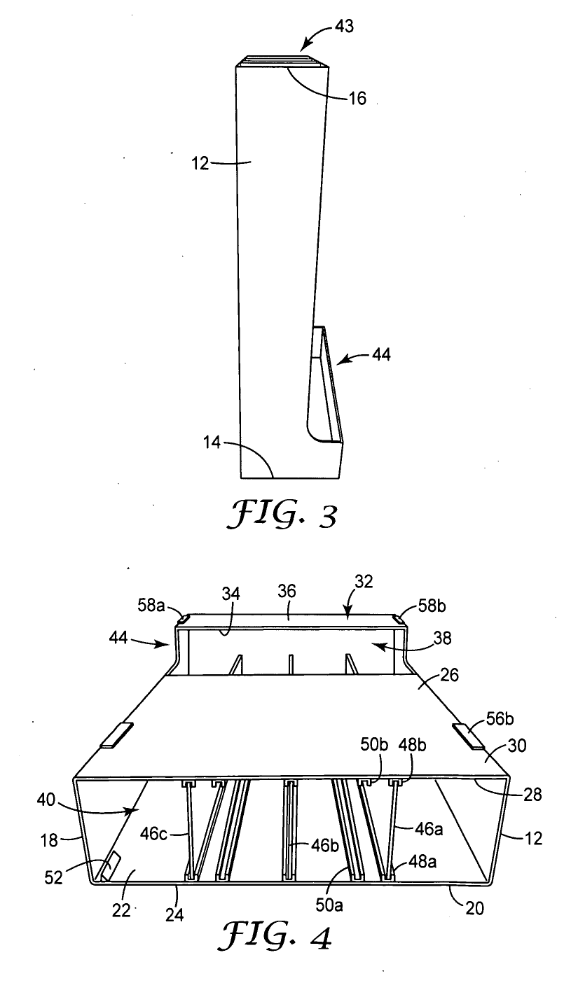

### DETAILED DESCRIPTION OF ILLUSTRATIVE EMBODIMENTS

As used herein, positional indicators such as top, bottom, upper, lower, etc. are used with reference to the typical upright orientation of the sidekick of the invention. The references cited herein are incorporated by reference in their entirety.

In brief summary, a sidekick 10 of the invention comprises:
a first side panel 12 which is wider at its bottom end 14 than at its top end 16;
a second side panel 18 substantially equal to the first side panel 12 in size and shape;
a back panel 20 having an interior surface 22 and an exterior surface 24 and extending from the first side panel 12 to the second side panel 18;
a front upper panel 26 having an interior surface 28 and an exterior surface 30 and extending from the first side panel 12 to the second side panel 18;
a front lower panel 32 having an interior surface 34 and an exterior surface 36 and extending from the first side panel 12 to the second side panel 18; and
a bottom panel 38 extending from the bottom end 14 of the first side panel 12 to the bottom end of the second side panel 18.

The side panels, back panel, front upper panel, front lower panel, and bottom panel define a cavity 40 in the sidekick where goods (not shown) are held. Typically, goods will be placed inside the cavity 40 in the sidekick 10 by insertion through the top 43 of the sidekick. Shoppers may remove the goods through the opening 44 which is defined by the position of front upper panel 26 and front lower panel 32 relative to each other.

Typically the cavity 40 within the interior of the sidekick 10 will be divided into two or more portions by one or more dividers 46a, 46b, and 46c. The dimensions of the dividers are dependent upon goods which may be held and sold from the sidekick. They should extend from the bottom panel of the side kick or at least sufficiently close thereto to prevent goods from moving undesirably from one side of the divider to the other and should extend upward toward the top of the sidekick as desired. Typically it will be preferred that the dividers do not extend beyond the top of the sidekick outside the cavity. As will be understood the dividers should extend sufficiently close to the top (and far from the bottom panel) as to effectively divide the cavity as desired.

In some embodiments, one or more of the dividers may be in fixed location. Such arrangement may impart greater structural integrity to the sidekick. In many embodiments, it is preferable that one or more of the dividers is removable. One of the advantages of sidekicks of the invention is repositioning the dividers to reconfigure the volume and shape of the cavity permits goods of varying size and shape to be held and sold from the sidekick as desired.

In one embodiment shown in FIG. 4, divider 46a is held by U-shaped guides 48a and 48b located on the interior surfaces of the back panel 20 and front panel 26, respectively. Divider 46a can be removed from the cavity by pulling and then inserted into guides 50a and 50b to provide a larger portion to the cavity. Other means for securing movable dividers will be apparent to those with ordinary skill in the art, including use of a single guide that provides sufficient stability to the divider, formation of recess(es) or channels into the face of the interior surface of the back panel, front panel, or both.

Sidekick 10 shown in FIG. 4 further comprises stop 52. If desired, extra dividers (such when cavity 40 is to be configured with fewer separate zones) may be stored within the cavity between stop 52 and side panel 18. Such storage when not in use reduces the likelihood that a divider will be lost during periods when it is not in use and makes it more convenient to reconfigure the cavity as desired by maintaining the various elements in close proximity.

As shown in FIG. 2, sidekick 10 also comprises optional extensions 54a, 54b, 54c, and 54d extending from the lower edge of front upper panel 26 into the opening 44. Such extensions may be formed integrally to upper front panel 26 or may be added to the lower edge of the front upper panel. The extensions provide better control of the goods (not shown) located within the cavity 40 so that the goods do not fall out through opening 44. In preferred embodiments, the extensions are flexible or hinged to facilitate reaching into the opening 44 while providing desired stability to the quantity of stored goods. In preferred embodiments, the extensions are mounted in repositionable fashion such that they can moved as desired in connection with reconfiguration of the dividers.

The side panels, front upper panel, front lower panel, back panel, and bottom panel may be made from separately formed sheets or pieces that are securely attached in the configuration of the invention or one or more of those components may be formed together, e.g., via molding plastic, from a single sheet or piece that is cut and/or shaped into desired configuration. The panels may be attached by appropriate means as can be readily selected by those with ordinary skill in the art, e.g., adhesive, welding, screws, nails, etc. depending upon the materials selected for the panels.

Typically it is preferred that the first and second side panels, back panel, front upper panel, front lower panel, bottom panel, and dividers are each substantially planar. As will be understood, however, one of more of such members may be made in non-planar shape if desired.

The sidekick is adapted to hold, preferably removably, desired decorative and/or communicative information. For example, a retailer may with to display sales or advertising information on the sidekick selection of which is dependent upon the goods being sold in the sidekick at that time. Typically the sidekick will be adapted to hold replaceable media on one or more of the side panels, front upper panel, and front lower panel. One such embodiment is shown in FIG. 4 where clips 56a and 56b are provided to secure a sheet (not shown) on upper front panel 26 and clips 58a and 58b are provided to secure a sheet (not shown) on lower front panel 32. The clips are positioned to hold a desired member (not shown) such as a paper or plastic sheet with desired information or graphics therein in place, and then in turn permit replacement of such sheet with another as the selection of goods in the sidekick is changed. For instance, a sidekick used to sell pens and other writing implements as part of a “back-to-school” display may be changed over to sell glow in the dark wrist bands, glow sticks, etc. for Halloween. Other means for adapting the sidekick to receive such media will be readily apparent to those skilled in the art, e.g., providing adhesive receptive surfaces, various forms of clips to hold desired media, etc.

In use, a sidekick of the invention will most typically be mounted in a substantially upright position on a suitable vertically oriented surface such as a wall, gondola, or endcap (not shown). The manner in which the sidekick is mounted may be readily selected dependent in part upon the features of the vertically oriented surface to which the sidekick is mounted, the features of the sidekick, collective weight of the sidekick and goods to be held therein, and intended permanence of the installation. When mounting to a gondola, for instance, many of the brackets, hangers, hooks, clips, bolts, screws, and other means used to secure shelves or other fixtures to the gondola may be used in accordance with the invention. U.S. Pat. No. 4,807,947 provides but one example may be used. Depending upon the particular installation, one or more of the back panel, side panels, and bottom panel of the sidekick may be adapted to permit mounting of the sidekick, e.g., by providing attachment points, connectors, attachment holes for receiving pins, brackets, etc.

Those skilled in the art can readily select suitable materials from which to fabricate the different elements of sidekicks of the invention. Illustrative examples of materials suitable for many applications include but are not limited to metal sheets, wire mesh, plastic (e.g., high impact plastics such as polycarbonate, polystyrene, ABS, etc.), corrugated cardboard (e.g., mylar coated corrugate), glass (e.g., tempered glass), and the like. In some embodiments, sidekicks will be fabricated using two or more materials.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. A merchandising device comprising:
a first side panel which is wider at its bottom end than at its top end;
a second side panel substantially equal to said first side panel in size and shape;
a back panel having an interior surface and an exterior surface and extending from said first side panel to said second side panel;
a front upper panel having an interior surface and an exterior surface and extending from said first side panel to said second side panel;
a front lower panel having an interior surface and an exterior surface and extending from said first side panel to said second side panel;
a bottom panel extending from the bottom of said first side panel to the bottom of said second side panel; and
one or more dividers;
wherein said first side panel, said second side panel, said back panel, said front upper panel, said front lower panel, and said bottom panel define a cavity, said one or more dividers extending at least partially into said cavity

2. The device of claim 1 wherein said first and second side panels, said back panel, said front upper panel, said front lower panel, and said bottom panel are each substantially planar.

3. The device of claim 1 wherein at least one of said first and second side panels, said front upper panel, and said front lower panel is adapted to receive a sheet bearing information or graphics.

4. The device of claim 1 wherein at least one of said dividers is in fixed location.

5. The device of claim 1 wherein at least one of said dividers is removable.

6. The device of claim 1 further comprising means to secure said device to an upright support.

7. The device of claim 1 mounted on a gondola.
